(19) United States
(12) Patent Application Publication
(10) Pub. No.: US 2026/0236268 A1
(43) Pub. Date: Aug. 13, 2026

(54) Dynamic Firmware Personality Orchestration

(71) Applicant: American Megatrends International, LLC, Duluth, GA (US)

(72) Inventors: Chitrak Gupta, Johns Creek, GA (US); Varadachari Sudan Ayanam, Suwanee, GA (US); Zachary Bobroff, Atlanta, GA (US)

(21) Appl. No.: 19/052,814

(22) Filed: Feb. 13, 2025

(51) Int. Cl. G06F 9/445; H04L 67/51

(52) U.S. Cl. CPC G06F 9/445; H04L 67/51

(57) ABSTRACT

One or more computing devices discover devices in a data center network using a plurality of discovery protocols. The one or more computing devices determine whether each discovered device has an associated personality information file defining capabilities and dependencies of the discovered device. For a discovered device that has the associated personality information file, the one or more computing devices enumerate supported personalities for the discovered device based on the personality information file. The one or more computing devices construct personality-based firmware for the discovered device based on the enumerated supported personalities.

### BACKGROUND

### Field

The present disclosure relates generally to computer systems, and more particularly, to techniques of managing firmware deployment across heterogeneous devices in a data center using dynamic personality-based firmware orchestration.

### Background

The statements in this section merely provide background information related to the present disclosure and may not constitute prior art.

Considerable developments have been made in the arena of server management. An industry standard called Intelligent Platform Management Interface (IPMI), described in, e.g., “IPMI: Intelligent Platform Management Interface Specification, Second Generation,” v.2.0, Feb. 12, 2004, defines a protocol, requirements and guidelines for implementing a management solution for server-class computer systems. The features provided by the IPMI standard include power management, system event logging, environmental health monitoring using various sensors, watchdog timers, field replaceable unit information, in-band and out of band access to the management controller, SNMP traps, etc.

A component that is normally included in a server-class computer to implement the IPMI standard is known as a Baseboard Management Controller (BMC). A BMC is a specialized microcontroller embedded on the motherboard of the computer, which manages the interface between the system management software and the platform hardware. The BMC generally provides the “intelligence” in the IPMI architecture.

The BMC may be considered as an embedded-system device or a service processor. A BMC may require a firmware image to make them operational. “Firmware” is software that is stored in a read-only memory (ROM) (which may be reprogrammable), such as a ROM, programmable read-only memory (PROM), erasable programmable read-only memory (EPROM), electrically erasable programmable read-only memory (EEPROM), etc.

Server infrastructure in data centers may follow a monolithic approach where Original Equipment Manufacturers (OEMs) provided complete, integrated server systems with predetermined configurations. These servers typically have bundled software and firmware that was specifically designed for the integrated hardware components. In this model, firmware management is relatively straightforward since all components were predetermined and tested for compatibility by the OEM vendor.

However, the emergence of cloud computing and the increasing demands for scalability and cost efficiency have driven a shift towards disaggregated and modular computing architectures. Cloud Service Providers (CSPs) began moving away from traditional OEM-supplied servers to directly sourcing components from Original Design Manufacturers (ODMs), leading to more heterogeneous environments where hardware components from multiple vendors need to work together. This shift created new challenges in firmware management, as different vendors often use different versions of firmware, leading to potential compatibility issues and operational complexities.

One approach to firmware management may involve manual updates or basic automation tools that were designed for homogeneous environments. These tools often lacked the capability to handle the complex dependencies between different firmware versions across various components, especially in environments where hardware components could be dynamically reconfigured or repurposed

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and a computer system are provided. The computer system includes one or more computing devices. The one or more computing devices discover devices in a data center network using a plurality of discovery protocols. The one or more computing devices determine whether each discovered device has an associated personality information file defining capabilities and dependencies of the discovered device. For a discovered device that has the associated personality information file, the one or more computing devices enumerate supported personalities for the discovered device based on the personality information file. The one or more computing devices construct personality-based firmware for the discovered device based on the enumerated supported personalities.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating a computer system including a baseboard management controller and a host computer.

FIG. 2 is a diagram illustrating a data center containing heterogeneous servers managed by multiple BMCs and a firmware deployment system.

FIG. 3 is a flow chart illustrating a process flow for dynamically managing firmware personalities in a data center environment using a cloud platform build orchestration system.

FIG. 4 is a flow chart illustrating a method for managing firmware personalities in a data center.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of computer systems will now be presented with reference to various apparatus and methods. These apparatus and methods will be described in the following detailed description and illustrated in the accompanying drawings by various blocks, components, circuits, processes, algorithms, etc. (collectively referred to as elements). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a processing system that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

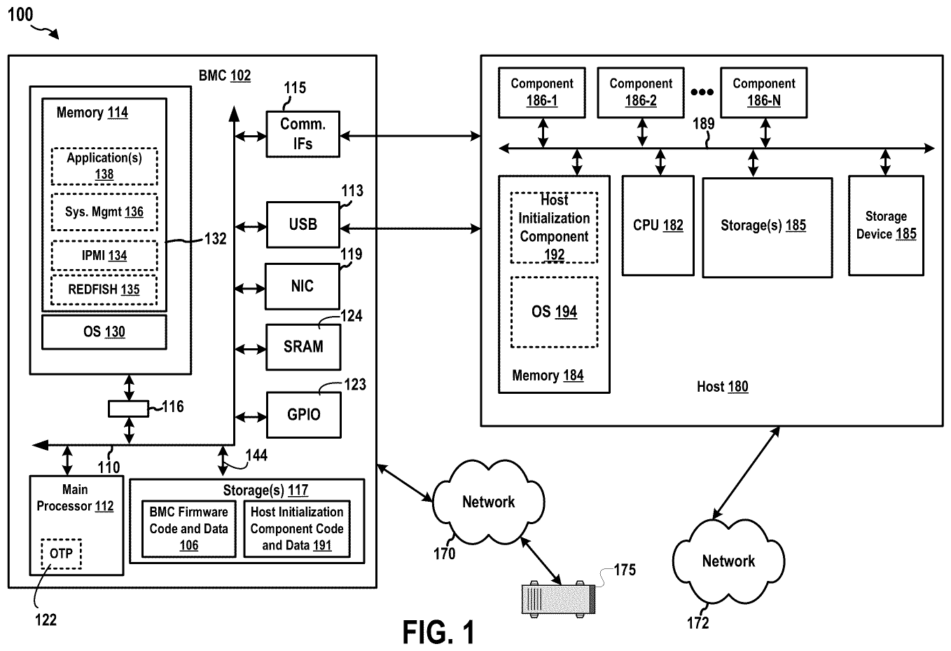

FIG. 1 is a diagram illustrating a computer system 100. In this example, the computer system includes, among other devices, a baseboard management controller (BMC) 102 and a host computer 180. The BMC 102 has, among other components, a main processor 112, a memory 114 (e.g., a dynamic random access memory (DRAM)), a memory driver 116, storage(s) 117, a network interface card 119, a USB interface 113 (i.e., Universal Serial Bus), other communication interfaces 115, a SRAM 124 (i.e., static RAM), and a GPIO interface 123 (i.e., general purpose input/output interface). Further, the main processing unit 112 contains an OTP memory 122 (i.e., one time programmable memory).

The communication interfaces 115 may include a keyboard controller style (KCS), a server management interface chip (SMIC), a block transfer (BT) interface, a system management bus system interface (SSIF), and/or other suitable communication interface(s). Further, as described infra, the BMC 102 supports IPMI and provides an IPMI interface between the BMC 102 and the host computer 180. The IPMI interface may be implemented over one or more of the USB interface 113, the network interface card 119, and the communication interfaces 115.

In certain configurations, one or more of the above components may be implemented as a system-on-a-chip (SoC). For examples, the main processor 112, the memory 114, the memory driver 116, the storage(s) 117, the network interface card 119, the USB interface 113, and/or the communication interfaces 115 may be on the same chip. In addition, the memory 114, the main processor 112, the memory driver 116, the storage(s) 117, the communication interfaces 115, and/or the network interface card 119 may be in communication with each other through a communication channel 110 such as a bus architecture.

The BMC 102 may store BMC firmware code and data 106 in the storage(s) 117. The storage(s) 117 may utilize one or more non-volatile, non-transitory storage media. During a boot-up, the main processor 112 loads the BMC firmware code and data 106 into the memory 114. In particular, the BMC firmware code and data 106 can provide in the memory 114 a BMC OS 130 (i.e., operating system) and service components 132. The service components 132 include, among other components, IPMI services 134, Redfish services 135, a system management component 136, and application(s) 138. Further, the service components 132 may be implemented as a service stack. As such, the BMC firmware code and data 106 can provide an embedded system to the BMC 102.

The BMC 102 may be in communication with the host computer 180 through the USB interface 113, the network interface card 119, the communication interfaces 115, and/or the IPMI interface, etc.

The host computer 180 includes a host CPU 182, a host memory 184, storage device(s) 185, and component devices 186-1 to 186-N. The component devices 186-1 to 186-N can be any suitable type of hardware components that are installed on the host computer 180, including additional CPUs, memories, and storage devices. As a further example, the component devices 186-1 to 186-N can also include Peripheral Component Interconnect Express (PCIe) devices, a redundant array of independent disks (RAID) controller, and/or a network controller.

Further, the storage(s) 117 may store host initialization component code and data 191 for the host computer 180. After the host computer 180 is powered on, the host CPU 182 loads the initialization component code and data 191 from the storage(s) 117 though the communication interfaces 115 and the communication channel 110. The host initialization component code and data 191 contains an initialization component 192. The host CPU 182 executes the initialization component 192. In one example, the initialization component 192 is a basic input/output system (BIOS). In another example, the initialization component 192 implements a Unified Extensible Firmware Interface (UEFI). UEFI is defined in, for example, “Unified Extensible Firmware Interface Specification Version 2.6, dated January 2016,” which is expressly incorporated by reference herein in their entirety. As such, the initialization component 192 may include one or more UEFI boot services.

The initialization component 192, among other things, performs hardware initialization during the booting process (power-on startup). For example, when the initialization component 192 is a BIOS, the initialization component 192 can perform a Power On System Test, or Power On Self Test, (POST). The POST is used to initialize the standard system components, such as system timers, system DMA (Direct Memory Access) controllers, system memory controllers, system I/O devices and video hardware (which are part of the component devices 186-1 to 186-N). As part of its initialization routine, the POST sets the default values for a table of interrupt vectors. These default values point to standard interrupt handlers in the memory 114 or a ROM. The POST also performs a reliability test to check that the system hardware, such as the memory and system timers, is functioning correctly. After system initialization and diagnostics, the POST surveys the system for firmware located on non-volatile memory on optional hardware cards (adapters) in the system. This is performed by scanning a specific address space for memory having a given signature. If the signature is found, the initialization component 192 then initializes the device on which it is located. When the initialization component 192 includes UEFI boot services, the initialization component 192 may also perform procedures similar to POST.

After the hardware initialization is performed, the initialization component 192 can read a bootstrap loader from a predetermined location from a boot device of the storage device(s) 185, usually a hard disk of the storage device(s) 185, into the host memory 184, and passes control to the bootstrap loader. The bootstrap loader then loads an OS 194 into the host memory 184. If the OS 194 is properly loaded into memory, the bootstrap loader passes control to it. Subsequently, the OS 194 initializes and operates. Further, on certain disk-less, or media-less, workstations, the adapter firmware located on a network interface card re-routes the pointers used to bootstrap the operating system to download the operating system from an attached network.

The service components 132 of the BMC 102 may manage the host computer 180 and is responsible for managing and monitoring the server vitals such as temperature and voltage levels. The service stack can also facilitate administrators to remotely access and manage the host computer 180. In particular, the BMC 102, via the IPMI services 134, may manage the host computer 180 in accordance with IPMI. The service components 132 may receive and send IPMI messages to the host computer 180 through the IPMI interface.

Further, the host computer 180 may be connected to a data network 172. In one example, the host computer 180 may be a computer system in a data center. Through the data network 172, the host computer 180 may exchange data with other computer systems in the data center or exchange data with machines on the Internet.

The BMC 102 may be in communication with a communication network 170 (e.g., a local area network (LAN)). In this example, the BMC 102 may be in communication with the communication network 170 through the network interface card 119. Further, the communication network 170 may be isolated from the data network 172 and may be out-of-band to the data network 172 and out-of-band to the host computer 180. In particular, communications of the BMC 102 through the communication network 170 do not pass through the OS 194 of the host computer 180. In certain configurations, the communication network 170 may not be connected to the Internet. In certain configurations, the communication network 170 may be in communication with the data network 172 and/or the Internet. In addition, through the communication network 170, a remote device 175 may communicate with the BMC 102. For example, the remote device 175 may send IPMI messages to the BMC 102 over the communication network 170.

Further, the storage(s) 117 is in communication with the communication channel 110 through a communication link 144.

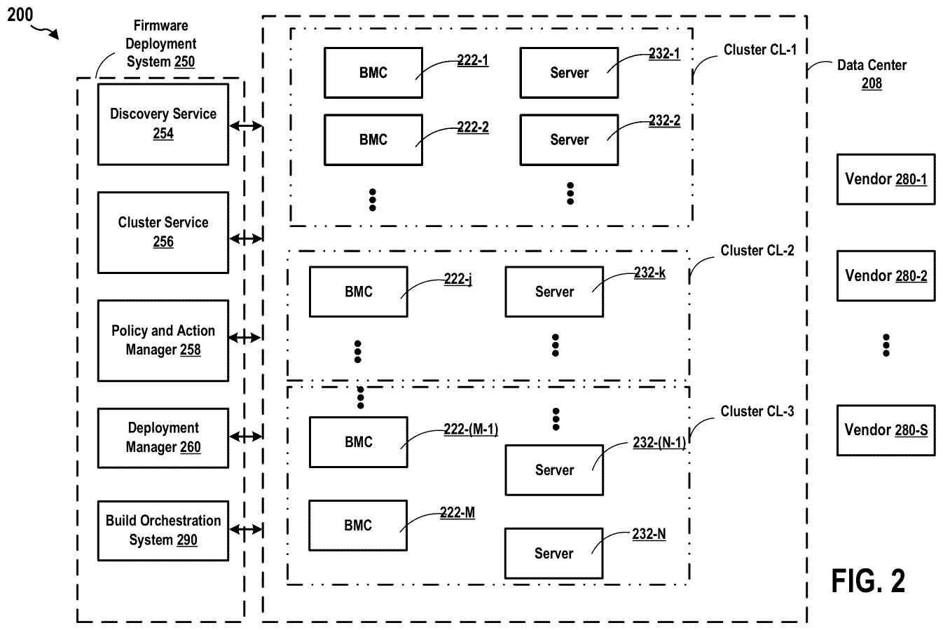

FIG. 2 is a diagram 200 illustrating a data center. In this example, a data center 208 includes heterogeneous servers 232-1, 232-2, . . . , 232-N. These servers represent the diverse array of hardware configurations typically found in modern data centers. To manage these servers, BMCs 222-1, 222-2, . . . , 222-M are employed, each responsible for monitoring and managing one or more servers. The hardware and software of the servers 232-1, 232-2, . . . , 232-N and of the BMCs 222-1, 222-2, . . . , 222-M may be provided by one or more of vendors 280-1, 280-2, . . . , 280-S.

In this example, the data center 208 represents a modern computing environment where traditional monolithic server architectures are evolving towards more dynamic, modular, and disaggregated configurations. The servers 232-1, 232-2, . . . , 232-N exemplify this transformation, as they may incorporate various combinations of computing resources, such as GPU sleds, CXL memory pools, and other specialized processing units, rather than following the conventional all-in-one server design traditionally supplied by OEMs.

The BMCs 222-1, 222-2, . . . , 222-M are deployed to manage these heterogeneous servers, with each BMC capable of adapting its functionality based on the specific hardware configuration it oversees. A BMC may serve multiple roles—it could manage a traditional server, coordinate a networking infrastructure, oversee GPU enclosures, or operate as a secondary BMC in a hierarchical management structure under a primary BMC's control.

The compute landscape is evolving towards a more modular, dynamic, and disaggregated architecture. Traditional models, where original equipment manufacturers (OEMs) like Dell or HP provide a complete, integrated server system, are gradually giving way to a new paradigm. Cloud service providers (CSPs) such as Microsoft, Amazon, and Google are increasingly investing in their own open standards and hardware designs, fostering a disaggregated hardware environment. This shift allows for flexible resource allocation, where components like GPUs, memory, and storage can be pooled and dynamically assigned based on workload demands.

A consequence of this transition is the proliferation of multi-vendor environments within data centers. Next-wave CSPs and telecommunication companies are adopting this approach to reduce costs and increase agility. However, managing a heterogeneous infrastructure presents significant challenges. Different vendors often utilize varying versions of firmware, leading to incompatibilities and operational complexities. For example, the vendors 280-1, 280-2, . . . , 280-S may each provide distinct versions or variants of firmware created by a firmware provider, leading to the presence of different feature sets or interface behaviors across otherwise comparable devices.

Further, the data center is in communication with a firmware deployment system 250, which includes several key components, as illustrated in FIG. 2. These components include a discovery service 254, a cluster service 256, a policy and action manager 258, a deployment manager 260, and a cloud platform build orchestration system (BOS) 290. Each of these services may be implemented on a computing device having a structure similar to that of the host computer 180. These components interact with the BMCs (e.g., the BMC 222-1 to BMC 222-M) and the servers (e.g., the servers 232-1 to 232-N) within the data center 208 to facilitate a controlled and scalable firmware deployment process.

The discovery service 254 is responsible for identifying and cataloging the various nodes within the data center 208. It communicates with the BMCs (e.g., the BMCs 222-1 to 222-M) to gather information about the servers, such as hardware configurations, firmware versions, and operational statuses. This information is stored and utilized to create clusters based on selectable parameters, such as workload types, CPU models, GPU types, operating systems, or firmware generations. By understanding what different nodes are present and how the racks are configured, the discovery service 254 enables the creation of clusters that simplify the management of firmware deployment policies.

The cluster service 256 utilizes the information collected by the discovery service 254 to organize the servers into logical clusters. Administrators can create selective filters to group servers with similar characteristics, such as all servers running Intel platforms or those equipped with specific GPUs. This clustering makes it easier to manage deployment policies by allowing firmware updates to be targeted to specific groups of servers. Clusters can also be created based on operating systems, enabling filters at different levels to accommodate various deployment strategies.

The policy and action manager 258 interprets the policy manifest defined by the administrators. This policy manifest, which may be in formats such as YAML or JSON, specifies the parameters controlling the firmware update process. It includes details such as which nodes or clusters to update, the sequence of deployment, scaling policies, error management strategies, and actions to be taken in response to specific events. The policy and action manager 258 understands these policies and orchestrates the deployment accordingly. As such, firmware updates can adhere to the administrator's specifications.

The deployment manager 260 orchestrates the actual deployment of firmware to the selected nodes or clusters. It communicates with the BMCs (e.g., the BMC 222-1 to BMC 222-M) to initiate firmware updates in an out-of-band manner, utilizing interfaces such as the network interface card 119. The firmware can be any type of firmware, including GPU firmware, CPLD firmware, FPGA firmware, or firmware for other hardware components. The deployment manager 260 thus provides a unified method for distributing updates across diverse hardware components within the data center.

The BOS 290 is a cloud-native firmware management service designed to continuously monitor and manage devices registered within the data center 208. The BOS 290 interfaces with the BMCs 222-1, 222-2, . . . , 222-M to orchestrate firmware deployment across the heterogeneous servers 232-1, 232-2, . . . , 232-N.

In modern data centers, the compute landscape is evolving towards a more modular, dynamic, and disaggregated architecture. As a result, data centers often include a diverse array of hardware configurations, incorporating components from various vendors 280-1, 280-2, . . . , 280-S. This heterogeneity introduces challenges in maintaining firmware consistency and compatibility, as different vendors may provide distinct firmware versions with varying features and dependencies.

To address these challenges, the BOS 290 applies a personality information file (PIF) alongside the firmware for each device under its management. The PIF is a metadata file created when the firmware for a particular device is constructed. It defines the capabilities and dependencies of the firmware, including specific firmware version dependencies, firmware capabilities, and device capabilities. Dependencies may include requirements for specific versions of other firmware components, compatibility constraints due to protocol handshakes, and hardware-specific features.

The BOS 290 enables the creation of customized firmware based on the capabilities of each device. By layering different functional blocks, the BOS 290 constructs firmware that matches the required functionality for a device. This layered approach allows the firmware to be tailored to control the personality of the device. For example, the layers can determine whether certain features are enabled or disabled, or whether specific protocols are supported, thereby controlling the personality and functionality of the device.

The BOS 290 works in conjunction with other key components of the firmware deployment system 250, including the discovery service 254, the cluster service 256, the policy and action manager 258, and the deployment manager 260. The discovery service 254 identifies and catalogs the various nodes within the data center 208, gathering information about hardware configurations, firmware versions, and operational statuses. This information is stored and utilized to create clusters based on selectable parameters.

Once the devices are discovered, the BOS 290 acquires metadata pertaining to each device's hardware configuration, operational state, and existing firmware version. The BOS 290 checks for the presence of a PIF for each device. If a PIF exists, the BOS 290 can enumerate the supported personalities for the device, allowing administrators to select the desired personality based on the device's capabilities and the requirements of the data center. If a PIF is not present, the BOS 290 analyzes the current firmware state and constructs an appropriate PIF for the device, capturing the capabilities and dependencies.

The personality information file captures dependencies that may arise from hardware constraints or protocol compatibility. For instance, a particular version of BMC firmware may only be compatible with specific BIOS versions due to protocol handshakes or shared features. If a BMC firmware version X requires BIOS version N, deploying it on a system with BIOS version N−1 could lead to incompatibilities or system instability. The PIF records such dependencies to prevent incompatible firmware combinations from being deployed.

The BOS 290 addresses the complexity of managing firmware across a heterogeneous environment by unifying diverse firmware revisions and variations. Different vendors may introduce diverging firmware versions for comparable hardware modules, leading to inconsistencies. The BOS 290 consolidates these differences by constructing layered firmware images that comply with the identified dependencies and capabilities outlined in the PIF.

By enabling the creation of customized firmware based on device capabilities, the BOS 290 allows for the management of a wide range of devices, including servers 232-1, 232-2, . . . , 232-N, BMCs 222-1, 222-2, . . . , 222-M, GPUs, FPGAs, xPUs, storage systems, and networking equipment. For example, a BMC that traditionally manages a server can be repurposed to manage networking infrastructure, GPU enclosures, or operate as a secondary BMC in a hierarchical management structure under a primary BMC's control. By applying an appropriate personality through the PIF and corresponding firmware configuration, the same hardware can be adapted to different roles within the data center.

When an updated firmware bundle is ready for deployment, the policy and action manager 258 interprets the defined policies and actions to determine the rollout strategy. The deployment manager 260 orchestrates the actual deployment of firmware to the selected nodes or clusters, communicating with the BMCs 222-1, 222-2, . . . , 222-M to initiate firmware updates in an out-of-band manner using interfaces such as the network interface card 119. The BMCs apply the new firmware image along with the PIF to their respective servers.

If a device transitions to a new functional role, the BOS 290 constructs a firmware image that reflects the new personality. For example, if a BMC is shifted from managing a single server to acting as a top-of-rack aggregator for multiple compute sleds, the BOS 290 generates firmware that incorporates the necessary features and protocols for the expanded management scope. This allows the same underlying hardware to handle a broader range of functionalities, enhancing the agility and scalability of the data center infrastructure.

An exemplary PIF is as follows:

personality:
workload: ″Memory Intensive″
cooling_technology: ″Liquid Cooled″
convergence: ″Fully Converged″
composition_state: ″Dynamically Composable″
cluster_state: ″Active″
criticality: ″High″
server_components:
- name: BIOS
current_version: ″2.4.0″
manufacturer: ″Dell″
- name: RAID Controller
current_version: ″8.2.1-0001″
manufacturer: ″LSI″
- name: Network Interface Card
current_version: ″7.10.5″
manufacturer: ″Intel″
- name: Power Supply Unit
current_version: ″1.3″
manufacturer: ″Delta Electronics″
- name: BMC
current_version: ″2.7.1″
manufacturer: ″Dell″
- name: CXL Memory Unit
current_version: ″1.2.0″
manufacturer: ″Samsung″
firmware_dependency_matrix:
BIOS:
- component: ″RAID Controller″
min_version: ″8.1.0-0000″
- component: ″Network Interface Card″
min_version: ″7.8.0″
- component: ″BMC″
min_version: ″2.5.0″
- component: ″CXL Memory Unit″
min_version: ″1.1.0″
RAID Controller:
- component: ″BIOS″
min_version: ″2.2.0″
Network Interface Card:
- component: ″BIOS″
min_version: ″2.3.0″
Power Supply Unit:
- component: ″BIOS″
min_version: ″2.0.0″
BMC:
- component: ″BIOS″
min_version: ″2.3.5″
CXL Memory Unit:
- component: ″BIOS″
min_version: ″2.4.0″

As shown, the PIF maintained by the BOS 290 contains structured metadata that defines both the operational characteristics and interdependencies of firmware across heterogeneous server environments. The PIF contains multiple sections that collectively describe a server's configuration, capabilities, and firmware version requirements.

The personality section of the PIF defines high-level operational characteristics of a server. For instance, a server may be designated for memory-intensive workloads, utilizing liquid cooling technology, and operating in a fully converged, dynamically composable state. This information allows the BOS 290 to optimize firmware configurations based on the server's intended role within the data center 208.

The server components section provides a detailed inventory of hardware components and their current firmware versions. Each component entry includes the manufacturer and version information, creating a comprehensive view of the server's firmware state. For example, a server might contain a BIOS version 2.4.0 from Dell, a RAID Controller version 8.2.1-0001 from LSI, and a CXL Memory Unit version 1.2.0 from Samsung.

The firmware dependency matrix section establishes version compatibility requirements between different components. This matrix is particularly important in preventing incompatible firmware combinations that could lead to system instability. For example, the matrix might specify that a BIOS version 2.4.0 requires a minimum BMC version of 2.5.0 for proper operation. These dependencies become increasingly complex in heterogeneous environments where components from vendors 280-1, 280-2, . . . , 280-S must interoperate seamlessly.

The BOS 290 utilizes this PIF information to orchestrate firmware updates across the servers 232-1, 232-2, . . . , 232-N through their respective BMCs 222-1, 222-2, . . . , 222-M. When a firmware update is proposed, the BOS 290 consults the firmware dependency matrix to validate that all version requirements will be satisfied post-update. This validation process helps maintain system stability by preventing the deployment of incompatible firmware combinations.

In dynamic environments where server personalities may change based on workload requirements, the BOS 290 can modify the PIF to reflect new operational characteristics and dependencies. For example, when a server transitions from a compute-intensive workload to a memory-intensive workload, the BOS 290 updates the PIF and may trigger firmware updates to optimize the server's performance for its new role.

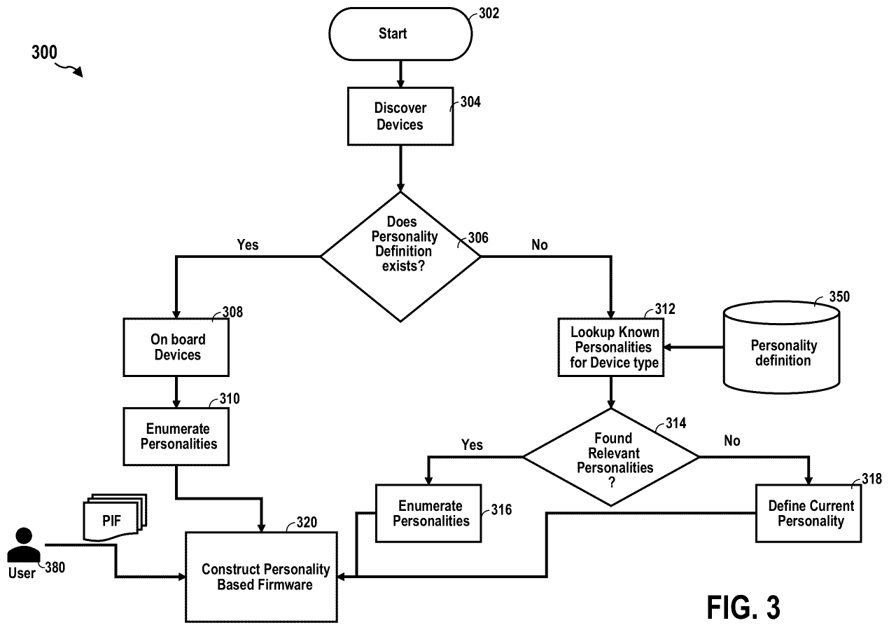

FIG. 3 is a flow chart 300 illustrating a process flow for dynamically managing firmware personalities in a data center environment using the cloud platform build orchestration system (BOS) 290. This process enables the BOS 290 to discover devices, manage firmware based on device personalities, and construct appropriate firmware images that match the capabilities and requirements of the devices within the data center 208.

In operation 302, the process begins with the start of the device registration to the BOS 290. The BOS 290 initiates the device discovery phase, preparing to identify and manage the various devices within the data center 208.

In operation 304, the BOS 290 discovers devices within the network of the data center 208. This discovery is facilitated through various discovery protocols supported by the devices. For example, the BOS 290 may use Redfish Discovery for BMCs such as the BMCs 222-1 to 222-M, as well as protocols like Avahi, Zero Configuration Networking (zeroconf), or the Link Layer Discovery Protocol (LLDP). These protocols allow the BOS 290 to identify devices regardless of the specific protocols supported by each device, accommodating a heterogeneous network environment.

In decision block 306, the BOS 290 determines whether each discovered device has an existing personality definition, typically in the form of a PIF. The PIF contains metadata about the device's capabilities, current firmware versions, hardware configurations, and firmware dependencies, as described in the previous sections. This file enables the BOS 290 to understand the operational characteristics and firmware requirements of the device.

If the device has an existing personality definition, the process proceeds to operation 308, where the BOS 290 onboards the device. Onboarding involves registering the device within the BOS 290 management framework, allowing the BOS 290 to manage firmware updates and configurations for the device effectively.

In operation 310, the BOS 290 enumerates the personalities supported by the device. By analyzing the PIF, the BOS 290 identifies the possible roles or configurations that the device can support. For example, a BMC may support different personalities, such as managing a single server, overseeing a GPU enclosure, or acting as a top-of-rack (ToR) aggregator in a disaggregated hardware environment. Enumerating these personalities allows the BOS 290 to tailor firmware updates to the specific functionalities required.

If the device does not have an existing personality definition, the process proceeds to operation 312, where the BOS 290 looks up known personalities for the device type. The BOS 290 accesses a personality definition database 350, which contains predefined personality definitions based on device types and configurations. This database may include entries for various hardware configurations, cooling technologies, workload types, and other operational characteristics, facilitating the identification of relevant personalities for the device.

In decision block 314, the BOS 290 determines whether relevant personalities are found for the device type in the personality definition database 350. If relevant personalities are found, the process advances to operation 316, where the BOS 290 enumerates the personalities similar to operation 310. This enumeration provides potential functionalities and roles that the device can undertake within the data center.

If no relevant personalities are found in the database, the process moves to operation 318. In this step, the BOS 290 defines the current personality of the device. The BOS 290 analyzes the device's hardware configuration, firmware versions, and operational status to construct a new personality definition. This may involve retrieving information from the device's BMC and interacting with the user 380 or an administrator to specify the desired personality. The user 380 provides input or requirements that guide the BOS 290 in defining the personality that aligns with the data center's needs.

In operation 320, the BOS 290 constructs personality-based firmware for the device. The BOS 290 reorganizes the firmware construction components to create a firmware image that aligns with the identified or defined personality of the device. This process may involve layering different functional blocks, enabling or disabling specific features, and incorporating the necessary dependencies specified in the PIF. By constructing firmware tailored to the device's personality, the BOS 290 enhances the device's performance and compatibility within the data center infrastructure.

During this firmware construction, the BOS 290 may receive input from the user 380, who can provide additional specifications or requirements for the firmware. The user 380 interacts with the BOS 290 through a user interface, supplying guidance on the desired features, performance optimizations, or roles for the device.

Once the personality-based firmware is constructed, the BOS 290 deploys the firmware to the device through the deployment manager 260. The deployment manager 260 communicates with the device's BMC (e.g., via the network interface card 119) to apply the new firmware image and update the PIF accordingly. The updated PIF reflects the new firmware versions and any changes in the device's capabilities or dependencies, maintaining an accurate record for future management tasks.

This process enhances the flexibility and scalability of firmware management within the data center environment. By dynamically constructing firmware based on device personalities and dependencies, the BOS 290 accommodates the diverse hardware configurations and operational requirements inherent in modern data centers. The use of PIFs allows for precise control over firmware interactions, preventing incompatibilities and optimizing device performance across various scenarios.

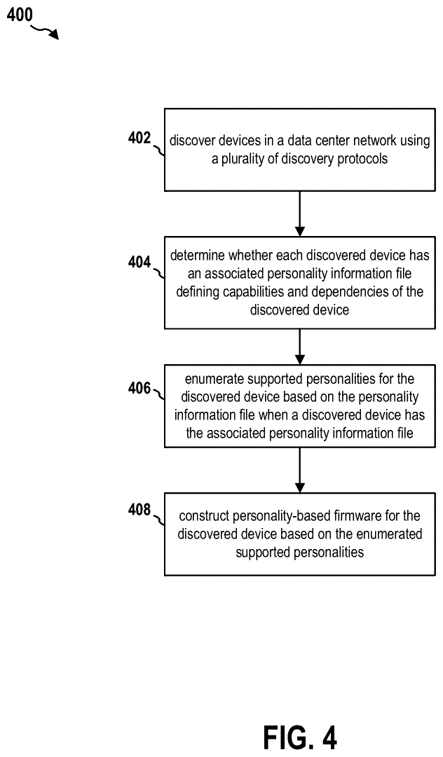

FIG. 4 is a flow chart 400 of a method for managing firmware personalities in a data center. The method may be performed by one or more computing devices (e.g., the cloud platform build orchestration system 290).

In operation 402, the one or more computing devices discover devices in a data center network using a plurality of discovery protocols. In operation 404, the one or more computing devices determine whether each discovered device has an associated personality information file defining capabilities and dependencies of the discovered device. In operation 406, when a discovered device has the associated personality information file, the one or more computing devices enumerate supported personalities for the discovered device based on the personality information file. In operation 408, the one or more computing devices construct personality-based firmware for the discovered device based on the enumerated supported personalities.

When the discovered device lacks the associated personality information file, the one or more computing devices look up known personalities for a device type of the discovered device in a personality definition database. The one or more computing devices determine whether relevant personalities are found for the device type. When relevant personalities are found, the one or more computing devices construct the personality-based firmware based on the relevant personalities.

When no relevant personalities are found for the device type, the one or more computing devices define a current personality for the discovered device based on hardware configuration and operational status of the discovered device, and construct the personality-based firmware based on the defined current personality.

In certain configurations, the plurality of discovery protocols comprise at least one of: Redfish discovery protocol, avahi protocol, zero configuration networking protocol, and link layer discovery protocol.

In certain configurations, the personality information file comprises a personality section defining operational characteristics, a server components section listing hardware components and firmware versions, and a firmware dependency matrix specifying version compatibility requirements between the hardware components. The firmware dependency matrix defines minimum version requirements between different firmware components to prevent deployment of incompatible firmware combinations.

The one or more computing devices receive user input specifying requirements for the personality-based firmware and construct the personality-based firmware based on the user input.

To construct the personality-based firmware, the one or more computing devices layer different functional blocks based on the supported personalities and enable or disable specific features based on dependencies specified in the personality information file.

In certain configurations, the personality information file defines at least one of workload characteristics, cooling technology, convergence state, composition state, cluster state, and criticality level for the discovered device.

The one or more computing devices update the personality information file when the discovered device transitions to a new functional role and construct new personality-based firmware reflecting capabilities required for the new functional role.

To discover devices, the one or more computing devices identify hardware configurations of the devices, determine current firmware versions, and gather operational status information through communication with baseboard management controllers (BMCs).

The one or more computing devices validate firmware dependencies specified in the personality information file before deploying the personality-based firmware.

The computing devices described in FIGS. 2-4, including components of the firmware deployment system 250 such as the discovery service 254, cluster service 256, policy and action manager 258, deployment manager 260, and cloud platform build orchestration system (BOS) 290, may each be implemented using a computing device having a structure similar to that of the host computer 180 shown in FIG. 1. Specifically, each of these components may include a host CPU 182, host memory 184, storage device(s) 185, and component devices 186-1 to 186-N, interconnected through appropriate communication channels. The host CPU 182 executes instructions stored in the host memory 184 to perform the respective functions of each service or system component, such as device discovery, personality enumeration, firmware construction, and deployment management.

The implementation of these components using the host computer 180 architecture enables efficient processing of firmware personality management tasks while maintaining communication with the BMCs 222-1 to 222-M through appropriate interfaces, similar to how the host computer 180 communicates with BMC 102 in FIG. 1. The storage device(s) 185 may store personality information files (PIFs), firmware images, and other data needed for managing firmware personalities across the data center, while the component devices 186-1 to 186-N may include network controllers and other hardware necessary for communicating with the managed devices and implementing the firmware deployment workflows illustrated in FIGS. 3 and 4.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method, implemented by one or more computing devices, comprising:
discovering devices in a data center network using a plurality of discovery protocols;
determining whether each discovered device has an associated personality information file defining capabilities and dependencies of the discovered device; and
when a discovered device has the associated personality information file:
enumerating supported personalities for the discovered device based on the personality information file; and
constructing personality-based firmware for the discovered device based on the enumerated supported personalities.

2. The method of claim 1, wherein when the discovered device lacks the associated personality information file, the method further comprises:
looking up known personalities for a device type of the discovered device in a personality definition database;
determining whether relevant personalities are found for the device type; and
when relevant personalities are found, constructing the personality-based firmware based on the relevant personalities.

3. The method of claim 2, wherein when no relevant personalities are found for the device type, the method further comprises:
defining a current personality for the discovered device based on hardware configuration and operational status of the discovered device; and
constructing the personality-based firmware based on the defined current personality.

4. The method of claim 1, wherein the plurality of discovery protocols comprise at least one of: Redfish discovery protocol, avahi protocol, zero configuration networking protocol, and link layer discovery protocol.

5. The method of claim 1, wherein the personality information file comprises:
a personality section defining operational characteristics;
a server components section listing hardware components and firmware versions; and
a firmware dependency matrix specifying version compatibility requirements between the hardware components.

6. The method of claim 5, wherein the firmware dependency matrix defines minimum version requirements between different firmware components to prevent deployment of incompatible firmware combinations.

7. The method of claim 1, further comprising:
receiving user input specifying requirements for the personality-based firmware; and
constructing the personality-based firmware based on the user input.

8. The method of claim 1, wherein constructing the personality-based firmware comprises:
layering different functional blocks based on the supported personalities; and
enabling or disabling specific features based on dependencies specified in the personality information file.

9. The method of claim 1, wherein the personality information file defines at least one of workload characteristics, cooling technology, convergence state, composition state, cluster state, and criticality level for the discovered device.

10. The method of claim 1, further comprising:
updating the personality information file when the discovered device transitions to a new functional role; and
constructing new personality-based firmware reflecting capabilities required for the new functional role.

11. The method of claim 1, wherein discovering devices comprises:
identifying hardware configurations of the devices;
determining current firmware versions; and
gathering operational status information through communication with baseboard management controllers (BMCs).

12. The method of claim 1, further comprising:
validating firmware dependencies specified in the personality information file before deploying the personality-based firmware.

13. A system, including one or more computing devices, comprising:
a memory; and
at least one processor coupled to the memory and configured to:
discover devices in a data center network using a plurality of discovery protocols;
determine whether each discovered device has an associated personality information file defining capabilities and dependencies of the discovered device; and
when a discovered device has the associated personality information file:
enumerate supported personalities for the discovered device based on the personality information file; and
construct personality-based firmware for the discovered device based on the enumerated supported personalities.

14. The system of claim 13, wherein when the discovered device lacks the associated personality information file, the at least one processor is further configured to:
look up known personalities for a device type of the discovered device in a personality definition database;
determine whether relevant personalities are found for the device type; and
when relevant personalities are found, construct the personality-based firmware based on the relevant personalities.

15. The system of claim 14, wherein when no relevant personalities are found for the device type, the at least one processor is further configured to:
define a current personality for the discovered device based on hardware configuration and operational status of the discovered device; and
construct the personality-based firmware based on the defined current personality.

16. The system of claim 13, wherein the plurality of discovery protocols comprise at least one of: Redfish discovery protocol, avahi protocol, zero configuration networking protocol, and link layer discovery protocol.

17. The system of claim 13, wherein the personality information file comprises:
a personality section defining operational characteristics;
a server components section listing hardware components and firmware versions; and
a firmware dependency matrix specifying version compatibility requirements between the hardware components.

18. The system of claim 17, wherein the firmware dependency matrix defines minimum version requirements between different firmware components to prevent deployment of incompatible firmware combinations.

19. The system of claim 13, wherein the at least one processor is further configured to:
receive user input specifying requirements for the personality-based firmware; and
construct the personality-based firmware based on the user input.

20. A non-transitory computer-readable medium storing computer executable code for operating one or more computing devices, comprising code to:
discover devices in a data center network using a plurality of discovery protocols;
determine whether each discovered device has an associated personality information file defining capabilities and dependencies of the discovered device; and
when a discovered device has the associated personality information file:
enumerate supported personalities for the discovered device based on the personality information file; and
construct personality-based firmware for the discovered device based on the enumerated supported personalities.
